(19) United States
(12) Patent Application Publication
(10) Pub. No.: US 2008/0036688 A1
(43) Pub. Date: Feb. 14, 2008

(54) Radio Device

(75) Inventors: Shinichiro Kawamura, Kyoto (JP); Shinji Hashiyama, Kyoto (JP); Yuzo Okano, Kyoto (JP); Tetsuo Shinkai, Kyoto (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi, Kyoto (JP)

(21) Appl. No.: 11/661,519

(22) PCT Filed: Apr. 7, 2005
(86) PCT No.: PCT/JP05/06876

§ 371 Date: Sep. 11, 2007

(30) Foreign Application Priority Data
Aug. 26, 2004 (JP) 2004-247474

(51) Int. Cl. H01Q 1/36; H01Q 1/38

(52) U.S. Cl. 343/895; 343/700 MS

(57) ABSTRACT

In order to provide a radio device which enables reducing its size regardless of the shape of a radio device antenna, a radio device includes a radio device antenna having a transmission/reception face A for transmitting and/or receiving signals, and a signal processing circuit for conducting predetermined processing on signals received at the radio device antenna and/or converting signals to be transmitted into signals adaptable to outputting from the radio device antenna. Further, in the radio device, a straight line (II)-(I) starting from a predetermined point (I) on the radio circuit board and extending from the predetermined point (I) in the direction opposite from the direction from the predetermined point (I) to a predetermined point (II) on the radio device antenna passes through a predetermined point (III) on the radio device antenna.

### TECHNICAL FIELD

The present invention relates to a radio device and more particularly relates to a radio device suitable for size reduction.

### BACKGROUND ART

In recent years, portable-type information processing devices having radio communication functions have remarkably come into wide use. These information processing devices employ, as radio communications, communications using radio waves with frequencies in the 2.4 GHz band (2.471 to 2.497 GHz), such as wireless LANs, in many cases.

As a radio device for use in such radio communications, it is possible to exemplify an USB radio module as illustrated in FIG. 10, for example.

As illustrated in FIG. 10, the radio device (USB radio module) 100 includes an USB plug 101 and a radio circuit board 102. The USB plug 101 is intended to be inserted into an USB insertion portion of an electronic device such as a personal computer or the like, not illustrated. Further, by inserting the USB plug 101 into the USB insertion portion of the electronic device, radio communications with the electronic device and its peripheral devices (printer, mouse and the like) are realized.

The radio circuit board 102 includes a signal processing board including a radio module 103, an USB module 104 and a radio device antenna 105 and a substrate 106. The radio circuit board 102 is structured by mounting the radio module 103, the USB module 104 and the radio device antenna 105 on the substrate 106.

The radio device antenna 105 transmits and receives predetermined radio signals. Further, the USB module 104 converts predetermined radio signals received at the radio device antenna 105 into USB signals and transmits them to the electronic device. Further, the USB module 104 converts USB signals from the electronic device into radio signals and transmits them to the radio device antenna 105.

However, the aforementioned conventional radio device has problems as follows.

Namely, in the aforementioned conventional radio device, the radio device antenna is mounted on the radio circuit board and, therefore, the shape of the radio device antenna restricts the area of the radio circuit board on which the signal processing circuit is mounted. Accordingly, in the aforementioned conventional radio device, the area of the radio circuit board on which the signal processing circuit is mounted is increased with enlarging shape of the radio device antenna. This results in the problem of increase of the size of the radio device along with the enlargement of the shape of the radio device antenna.

Furthermore, if plural radio device antennas are provided in a radio device, this increases the size of the radio device, which may make the radio device impractical.

### DISCLOSURE OF THE INVENTION

The present invention was made in view of the aforementioned problems in the prier art and aims at providing a radio device which enables reducing its size regardless of the shape of a radio device antenna.

In order to overcome the aforementioned object, a radio device according to the present invention is a radio device including a radio device antenna for transmitting and/or receiving signals, and a signal processing circuit for conducting predetermined processing on signals received at the aforementioned radio device antenna and/or converting signals to be transmitted into signals adaptable to outputting from the aforementioned radio device antenna, wherein the aforementioned radio device antenna is constituted by one or more electrodes, and there is at least a single straight line passing through the aforementioned signal processing circuit, out of straight lines connecting arbitrary two points on a single electrode out of the aforementioned plural electrodes.

The radio device according to the present invention conducts, with the signal processing circuit, predetermined processing on signals received at the aforementioned radio device antenna and/or converts, with the signal processing circuit, signals to be transmitted into signals adaptable to outputting from the radio device antenna, for performing radio communications.

With the aforementioned structure, the aforementioned radio device antenna is constituted by one or more electrodes, and there is at least a single straight line passing through the signal processing circuit, out of straight lines connecting arbitrary two points on a single electrode out of the aforementioned plural electrodes. Namely, there is at least a single straight line which passes through two points on a single electrode out of the aforementioned one or more electrodes, out of straight lines passing through an arbitrary single point on the aforementioned signal processing circuit.

Accordingly, with the aforementioned structure, the signal processing circuit is surrounded by a predetermined face or straight line in a single electrode in the radio device antenna. This can utilize, more effectively, the area surrounded by the predetermined face or straight line in the single electrode in the radio device antenna, thereby realizing a radio device with a further reduced size.

Also, the aforementioned radio device antenna can be a planar antenna.

The aforementioned “planar antenna” means an antenna having a bar-shaped member placed within the same plane. The planar antenna according to the present invention includes patch antennas having various shapes, for example, antennas having rectangular cylindrical shapes and circular cylindrical shapes.

With the aforementioned structure, the planar antenna is configured in such a way as to surround the signal processing circuit by a predetermined bar-shaped member, which enables effectively utilizing the area surrounded by the aforementioned bar-shaped member, thereby realizing reduction of the size of the radio device.

Further, in the radio device according to the present invention, preferably, the aforementioned radio device antenna is a discone-shaped antenna having a conical-face shaped face and a planar surface, and at least a portion of the aforementioned signal processing circuit is placed in the area surrounded by the aforementioned conical-face shaped face.

The “discone-shaped antenna” means an antenna constituted by an electrode (cone) having a conical-face shape and an electrode (disk) having a planar surface provided near the vertex of the conical-face shape concentrically with and perpendicularly to the center line thereof.

In the aforementioned “discone-shaped antenna”, the area surrounded by the aforementioned conical-face shaped surface is an area which does not function as an antenna.

With the aforementioned structure, at least a portion of the aforementioned signal processing circuit is placed in the area surrounded by the conical-face shaped surface, which enables effectively utilizing the area surrounded by the conical-face shaped surface, which does not function as an antenna, in the radio device including the discone-shaped radio device antenna, thereby realizing reduction of the size of the radio device.

Further, in the radio device according to the present invention, preferably, the aforementioned radio device antenna is a helical antenna having a helical shape, and at least a portion of the aforementioned signal processing circuit is placed in the area surrounded by the aforementioned helical shape.

The “helical antenna” means an antenna having a helically wound electric wire, namely an electric wire wound in a coil shape.

With the aforementioned structure, at least a portion of the aforementioned signal processing circuit is placed in the area surrounded by the aforementioned helical shape, which enables effectively utilizing the area surrounded by the conical-face shaped surface, which does not function as an antenna, in the radio device including the discone-shaped radio device antenna, thereby realizing reduction of the size of the radio device.

Further, in the radio device according to the present invention, preferably, at least a portion of the aforementioned signal processing circuit is shaped in conformance to the shape of the aforementioned radio device antenna.

The term “a shape conforming to the shape of the radio device antenna” means a shape of the edge portion of the aforementioned signal processing circuit which faces to the aforementioned radio device antenna which is inclined in conformance to the shape of the aforementioned radio device antenna.

By shaping at least a portion of the aforementioned radio circuit board as described above, it is possible to place the radio device antenna and the radio circuit board with a reduced interval interposed therebetween, which enables utilizing, more effectively, the area surrounded by a predetermined face or straight line in the radio device antenna. This can realize a radio device with a reduced size.

Further, the radio device according to the present invention preferably includes a layer made of a high dielectric loss tangent material, between the aforementioned radio device antenna and the aforementioned signal processing circuit.

With the aforementioned structure, the layer made of the high dielectric loss tangent material reduces noises generated from the aforementioned signal processing circuit. This can reduce the influence of noises on the radio device antenna, thereby enabling provision of a radio device having improved transmission/reception sensitivity.

Further, preferably, the radio device according to the present invention includes connection means for connecting the aforementioned radio device antenna and the aforementioned signal processing circuit to each other,

wherein the aforementioned connection means is provided between the aforementioned radio device antenna and the aforementioned signal processing circuit.

With the aforementioned structure, the connection means is provided between the aforementioned radio device antenna and the aforementioned signal processing circuit, namely the area surrounded by a predetermined face or straight line in the aforementioned radio device antenna. This enables effectively utilizing the area surrounded by the predetermined face or straight line in the aforementioned radio device antenna, for connecting the aforementioned radio device antenna and the aforementioned radio circuit board. This enables realization of a radio device with a further reduced size.

Further, in the radio device according to the present invention, preferably, the aforementioned connection means includes a connecter at its side closer to the aforementioned radio device antenna and includes an insertion electrode at its side closer to the aforementioned signal processing circuit, wherein the aforementioned connecter and the aforementioned insertion electrode are connected to each other in an insertion manner.

With the aforementioned structure, the aforementioned radio device antenna and the aforementioned radio circuit board are connected to each other in an insertion manner, which can reduce the number of components in the radio device. This enables realization of reduction of the cost of the radio device.

Further, in the radio device according to the present invention, preferably, the aforementioned connection means connects the aforementioned radio device antenna and the aforementioned signal processing circuit to each other through a conductive elastic member, wherein there is further provided securing means for securing the aforementioned radio device antenna and the aforementioned signal processing circuit.

With the aforementioned structure, the aforementioned radio device antenna and the aforementioned radio circuit board are connected to each other through the conductive elastic member, which can simplify the processing for connection, in comparison with cases of connecting a radio device antenna and a radio circuit board to each other through soldering.

Further, in the radio device according to the present invention, preferably, the aforementioned radio device antenna is a passive device, and the aforementioned signal processing circuit is provided with a resonant antenna for propagating radio waves to the aforementioned radio device antenna through resonance.

With the aforementioned structure, the resonant antenna propagates radio waves to the radio device antenna through resonance. Therefore, the radio device antenna functions as an antenna, even at passive states. This can eliminate the necessity of providing connection means for electrically connecting the radio device antenna to the radio circuit board, thereby largely reducing the number of components. This enables further reduction of the size of the radio device.

There is no particular limitation on the placement of the aforementioned radio device antenna and the aforementioned signal processing circuit, provided that there is at least a single straight line passing through the aforementioned signal processing circuit, out of straight lines connecting arbitrary two points on a single electrode out of the plural electrodes in the radio device antenna, as described above. However, it is possible to exemplify a structure in which the radio device antenna is placed at a corner portion of the radio circuit board having the signal processing circuit mounted thereon.

Other objects, features and advantages of the present invention will become sufficiently apparent from the following specification.

### BRIEF DESCRIPTION OF THE DRAWINGS

FIG. 1 is a cross-sectional view illustrating the general structure of a radio device according to a first embodiment of the present invention.

FIG. 2 is a cross-sectional view illustrating the general structure of a radio device including a layer made of a high dielectric loss tangent material, according to the first embodiment of the present invention.

FIG. 3 is a cross-sectional view illustrating the general structure of a radio device employing an insertion-type connection for connecting a radio device antenna and a radio circuit board to each other, according to the first embodiment of the present invention.

FIG. 4 is a cross-sectional view illustrating the general structure of a radio device employing an elastomer connection for connecting a radio device antenna and a radio circuit board to each other, according to the first embodiment of the present invention.

FIG. 5A is a cross-sectional view illustrating the elastomer connection between the radio device antenna and the radio circuit board, prior to pressing.

FIG. 5B is a cross-sectional view illustrating the elastomer connection between the radio device antenna and the radio circuit board, after the pressing.

FIG. 6 is a cross-sectional view illustrating the general structure of a radio device according to a second embodiment of the present invention.

FIG. 7A is an explanation view for describing a radio device according to a third embodiment in a case where a radio device antenna has a discone shape, illustrating the step of covering a plug with a cap antenna.

FIG. 7B is an explanation view for describing the radio device according to the third embodiment in a case where the radio device antenna has a discone shape, illustrating the step of removing the cap antenna from the plug.

FIG. 7C is an explanation view for describing the radio device according to the third embodiment in a case where the radio device antenna has a discone shape, illustrating the step of moving the cap antenna to a tip end of a radio circuit board case.

FIG. 7D is an explanation view for describing the radio device according to the third embodiment in a case where the radio device antenna has a discone shape, illustrating the step of mounting the cap antenna to the radio circuit board case.

FIG. 8A is an explanation view for describing a radio device according to the third embodiment in a case where a radio device antenna is a helical antenna, illustrating the step of covering a plug with a cap antenna.

FIG. 8B is an explanation view for describing the radio device according to the third embodiment in a case where the radio device antenna is a helical antenna, illustrating the step of removing the cap antenna from the plug.

FIG. 8C is an explanation view for describing the radio device according to the third embodiment in a case where the radio device antenna is a helical antenna, illustrating the step of moving the cap antenna to a tip end of a radio circuit board case.

FIG. 8B is an explanation view for describing the radio device according to the third embodiment in a case where the radio device antenna is a helical antenna, illustrating the step of mounting the cap antenna to the radio circuit board case.

FIG. 9A is a perspective view illustrating an example of the shape of the aforementioned radio device, in a case where the radio device has a rectangular cylindrical shape.

FIG. 9B is a perspective view illustrating an example of the shape of the aforementioned radio device, in a case where the radio device has an elliptical cylindrical shape.

FIG. 10 is a plane view illustrating the general structure of a conventional radio device.

FIG. 11 is a cross-sectional view illustrating the general structure of a radio device in a case where a radio device antenna has a discone shape.

FIG. 12 is a cross-sectional view illustrating the general structure of a radio device in a case where a radio device antenna is a helical antenna.

### BEST MODE FOR CARRYING OUT THE INVENTION

### First Embodiment

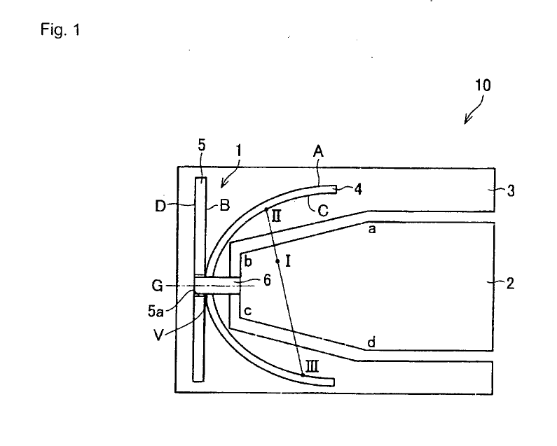

With reference to FIGS. 1 to 5, there will be described a first embodiment of the present invention, in the following description. However, the present invention is not limited thereto.

FIG. 1 illustrates the configuration of main parts of a radio device 10 according to the present embodiment. As illustrated in FIG. 1, the radio device 10 includes a radio device antenna 1, a radio circuit board (signal processing circuit) 2, and a case 3 which covers the radio device antenna 1 and the radio circuit board 2.

The radio device antenna 1 has a transmission/reception face for transmitting and receiving radio waves. There will be described, as an example of the radio device antenna 1, a discone-shaped antenna constituted by an electrode (cone) having a circular conical face shape and an electrode (disk) having a disk shape provided near the vertex of the circular conical face shape concentrically with and perpendicularly to the center line thereof. Namely, the radio device antenna 1 includes a feeding electrode 4, an earth electrode 5 and a feeding electrode 6.

The feeding electrode 4 is an electrode made of a conductor and has a shape corresponding to the conical face (circular conical face) of a circular conical member. Further, while, in FIG. 1, the feeding electrode 4 is illustrated as having a bell shape, it is merely schematically illustrated for ease of understanding a “non-sensitive area” which will be described later.

The earth electrode 5 is an electrode made of a conductor and having a disk shape provided with a cylindrical through hole 5a concentrical to the center thereof. The earth electrode 5 is provided perpendicularly to the center line of the circular conical face of the feeding electrode 4. Further, the earth electrode 5 is placed such that its center line is positioned at the center of the through hole 5a. Further, near the height of the surface of the earth electrode 5 closer to the feeding electrode 4, there is placed the vertex V of the circular conical surface of the feeding electrode 4. Namely, the center line of the circular conical face of the feeding electrode 4, the center line of the disk of the earth electrode 5 and the center line of the cylindrical face of the through hole 5a are all coincident with a common center line G. The earth electrode 5 can be formed from a metal plate member, for example.

The feeding terminal 6 is a terminal made of a conductor and having a circular cylindrical shape or a tubular shape and is placed in the through hole 5a of the earth electrode 5 such that its center line is coincident with the center line G. The feeding terminal 6 is spaced apart from the inner peripheral surface of the through hole 5a of the earth electrode 5 and, thus, is electrically insulated from the earth electrode 5. Further, the connection portion between the feeding terminal 6 and the feeding electrode 4, namely the vertex V of the feeding electrode 4, is referred to as a feeding portion. Namely, the radio device 10 includes the feeding terminal 6, as a connection means.

The radio circuit board 2 conducts predetermined processes on radio signals received at the radio device antenna 1 for transmitting predetermined electrical signals to an electronic device such as a personal computer and/or converts predetermined electrical signals to be transmitted to the electronic device into radio signals applicable to output from the radio device antenna 1. Namely, although not illustrated in FIG. 1, the radio circuit board 2 is configured to include a radio module for converting predetermined electrical signals into radio signals, an electrical signal module for converting radio signals into predetermined electrical signals and the like, which are mounted on the board. Further, the aforementioned “predetermined electrical signals” means electrical signals for use in connecting the radio device 10 to an electronic device such as a personal computer. Therefore, in the radio device 10, the “predetermined electrical signals” can be properly defined depending on the electrical device to be connected thereto. Such “predetermined electrical signals” can be, for example, USB signals, IEEE 1394 signals, differential transmission signals, and the like.

In the radio device 10, the radio device antenna 1 and the radio circuit board 2 are provided separately from each other, as described above. Namely, the radio device antenna 1 is not mounted on the radio circuit board 2. Accordingly, in comparison with a radio device including a radio device antenna mounted on a conventional radio circuit board, the radio device 10 enables reducing the size thereof by an amount corresponding to the area of the radio circuit board for mounting the radio device antenna. Further, even when the radio device antenna 1 is a large-sized antenna which would occupy a large part of the mounting area of the radio circuit board 2, it is possible to reduce the size of the radio device.

If electricity is supplied to the vertex V of the feeding electrode 4 when a radio wave is transmitted through the radio device antenna 1, then a radio wave having a predetermined frequency is generated from the face A of the feeding electrode 4 and the face B of the earth electrode 5. Then, the radio wave propagates between the feeding electrode 4 and the earth electrode 5 while spreading in a spherical shape concentrical with the vertex X. Further, when receiving a radio wave, the radio device antenna 1 receives the radio wave at the face A of the feeding electrode 4 and the face B of the earth electrode 5.

As described above, the radio device antenna 1 uses the face A of the feeding electrode 4 having a conical-face shaped surface and the face B of the earth electrode 5 having a planar surface, as transmission/reception faces. Further, the radio circuit board 2 is placed in a non-sensitive area of the face A of the feeding electrode 4 which is the transmission/reception face thereof. In this case, the term “non-sensitive area” refers to the area of the radio device antenna 1 which does not function as an antenna, namely the area which does not transmit and receive radio waves. In the radio device antenna 1, the face A of the feeding electrode 4 forms a transmission/reception face and functions as an antenna. On the other hand, the face C of the feeding electrode 4 opposite from the face A thereof does not transmit and receive radio waves and does not function as an antenna. Accordingly, the aforementioned “non-sensitive area” includes the area surrounded by the face C of the feeding electrode 4.

Further, in the radio device 1, a straight line II-I starting from a predetermined point I on the radio circuit board 2 and extending from the predetermined point I in the direction opposite from the direction from the predetermined point I to a predetermined point II on the radio device antenna 1 passes through a predetermined point III on the radio device antenna 1.

Namely, the radio device 10 is configured such that there is at least a single line passing through the radio circuit board 2 (for example, the straight line connecting the point II and the point III to each other, in FIG. 1), out of straight lines connecting predetermined two points on the radio device antenna 1.

In the radio device 10, the radio circuit board 2 is placed in the area surrounded by the face C of the feeding electrode 4 which is a non-sensitive area thereof. Therefore, the radio device 10 enables effective utilization of the area surrounded by the face C of the feeding electrode 4, thereby realizing reduction of the size of the radio device.

Further, there is no particular limitation on the “discone-shaped antenna” according to the present invention, provided that it has a conical-face shaped surface and a planar surface. The aforementioned conical-face shaped surface means the side face of a rotational member having an axis coincident with the center line G. Accordingly, the conical-shaped face of the “discone-shaped antenna” can be either the side surface of a rotational member having a conical-shaped or a bell-shaped vertex or can be the side surface of a rotational member having a flatted vertex.

Also, the radio device antenna according to the present invention can be a biconical antenna having two conical-shaped electrodes placed symmetrically such that their vertexes are coincident with each other.

Further, in the radio device 10, the feeding electrode 4 is covered by the case 3. Further, in the radio device 10, the edge portion of the radio circuit board 2 near the radio device antenna 1 has a shape conforming to the face C of the feeding electrode 4. In this case, “a shape conforming to the face C of the feeding electrode 4” means a shape of the edge portion of the radio circuit board 2 near the radio device antenna 1 which is inclined in conformance to the face C of the feeding electrode 4, when viewed opposite to the surface of the radio circuit board 2. In the radio device 10, the edge portions of the radio circuit board 2 have a trapezoidal shape connecting points a, b, c and d to one another, when viewed oppositely with the surface of the radio circuit board 2. Out of the edge portions of the radio circuit board 2, the edge portions ab and cd are inclined in conformance to the face C of the feeding electrode 4. Further, “a shape conforming to the face C of the feeding electrode 4” includes a shape of the cabinet which covers the face C of the feeding electrode 4, in addition to the shape of the face C itself of the feeding electrode 4.

By shaping the end portions of the radio circuit board 2 as described above, it is possible to place the radio device antenna 1 and the radio circuit board 2 without interposing a gap therebetween, thereby utilizing the area surrounded by the face C of the feeding electrode 4 more efficiently. This can realize reduction of the size of the radio device.

Further, in the radio device 10, the feeding terminal 6 as a connection means is provided between the radio device antenna 1 and the radio circuit board 2. This enables effectively utilizing the area surrounded by the face C of the radio device antenna 1 for connecting the radio device antenna 1 to the radio circuit board 2. This enables reduction of the size of the radio device.

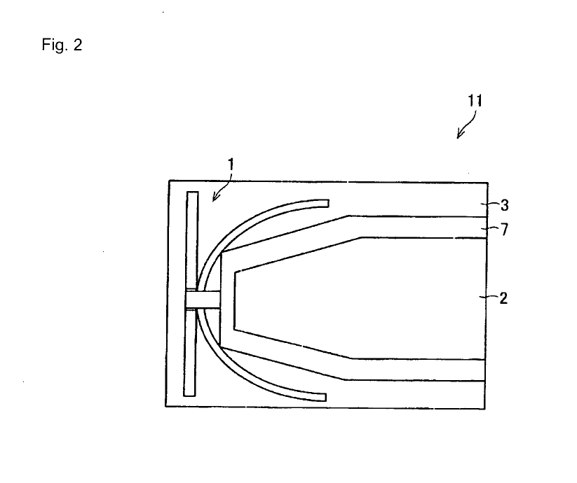

Further, preferably, there is provided a layer made of a high dielectric loss tangent material, between the case covering the radio device antenna 1 and the radio circuit board 2. Hereinafter, with reference to FIG. 2, there will be described a radio device 11 including a layer made of a high dielectric loss tangent material. FIG. 2 is a cross-sectional view illustrating the general structure of the radio device 11 including the layer made of the high dielectric loss tangent material. As illustrated in FIG. 2, in the radio device 11, a high dielectric loss tangent layer (a layer made of a high dielectric loss tangent material) 7 is provided, between the case 3 covering the radio device antenna 1 and the radio circuit board 2.

The high dielectric loss tangent layer 7 reduces noises generated from the radio circuit board 2. This can reduce the influence of noises on the radio device antenna 1, thereby further improving the transmission/reception sensitivity of the radio device.

The aforementioned “high dielectric loss tangent material” means a material having a higher high dielectric loss tangent (tan δ). The “dielectric loss tangent” means the tangent of the complementary angle of the phase difference angle between a sinusoidal-wave voltage applied to the dielectric material and an electric current component having the same frequency as that of the applied voltage, out of electric currents flowing through the dielectric material, when the sinusoidal-wave voltage is applied to the dielectric member. The higher the dielectric loss tangent, the higher the effect of suppressing passage of high-frequency signals (the higher the transmission loss).

Further, in the radio device 11, the dielectric loss tangent of the high dielectric loss tangent layer 7 can be properly set, depending on the size of the radio device antenna 1 or the size of the radio circuit board 1.

Further, there is no particular limitation on such a high dielectric loss tangent material, provided that it is a conventionally well known material having a higher dielectric loss tangent, but such a high dielectric loss tangent material can be PPS, LCP or PBT, and it is preferably PPS. PPS has a dielectric loss tangent of about 0.1.

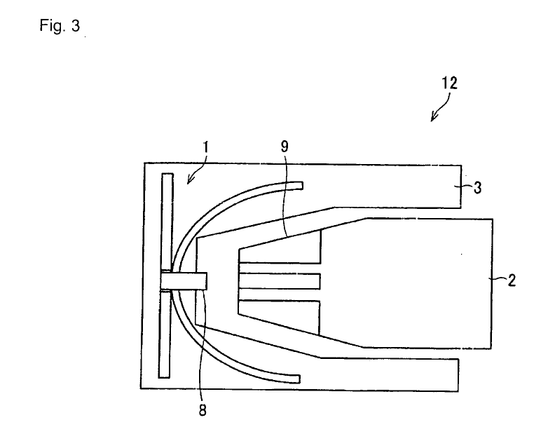

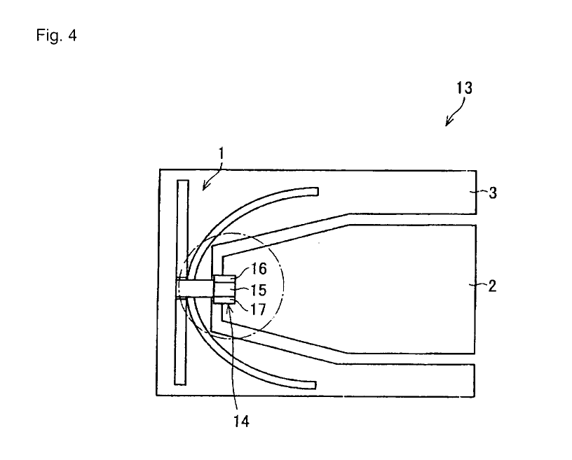

Further, in the radio device 11, the radio device antenna 1 and the radio circuit board 2 are connected to each other through the aforementioned feeding portion. Further, the radio device antenna 1 and the radio circuit board 2 can not be disconnected from each other. Although there is no particular limitation on the connection between the radio device antenna 1 and the radio circuit board 2, provided that it is a conventionally well known connection, but it is preferable to utilize an insertion-type connection or a connection through an elastomer. Hereinafter, with reference to FIG. 3 and FIG. 4, there will be described the connection between the radio device antenna 1 and the radio circuit board 2. FIG. 3 is a cross-sectional view illustrating the general structure of a radio device 12 including a radio device antenna 1 and a radio circuit board 2 connected to each other through an insertion-type connection. FIG. 4 is a cross-sectional view illustrating the general structure of a radio device 13 including a radio device antenna 1 and a radio circuit board 2 connected to each other through a connection using an elastomer.

As illustrated in FIG. 3, in the radio device 12, a connector 8 is provided at a feeding portion of the radio device antenna 1. Further, the radio circuit board 2 is provided with an insertion electrode 9 to be connected to the connector 8 in an insertion manner. By connecting the connector 8 to the insertion electrode 9, the radio device antenna 1 and the radio circuit board 2 are electrically connected to each other. Namely, the radio device 12 includes the connector 8 and the insertion electrode 9, as connection means.

By connecting the radio device antenna 1 and the radio circuit board 2 to each other through an insertion manner, as described above, it is possible to reduce the number of components of the radio device 12. This can reduce the cost of the radio device 12.

Also, a radio device antenna 1 and a radio circuit board 2 can be connected to each other through a connection using an elastomer, as illustrated in FIG. 4.

As illustrated in FIG. 4, an elastomer connection portion 14 is provided between the feeding portion of the radio device antenna 1 and the radio circuit board 2, in the radio device 13. The elastomer connection portion 14 includes a metal line layer 15 and elastic layers 16 and 17 (hereinafter, referred to as elastic layers 16, 17).

Further, the elastomer connection portion 14 is constituted by the elastic layer 16, the metal line layer 15 and the elastic layer 17 which are laminated in this order. Namely, the elastomer connection portion 14 is constituted by the elastic layers 16, 17 and the metal line layer 15 sandwiched therebetween. Further, in the radio device 13, the radio device antenna 1 and the radio circuit board 2 are connected to each other through the elastomer connection portion 14, perpendicularly to the direction of lamination of the elastic layer 16, the metal line layer 15 and the elastic layer 17. Further, by pressing the radio device antenna 1 and the radio circuit board 2 against each other, it is possible to realize electrical connection between the radio device antenna 1 and the radio circuit board 2.

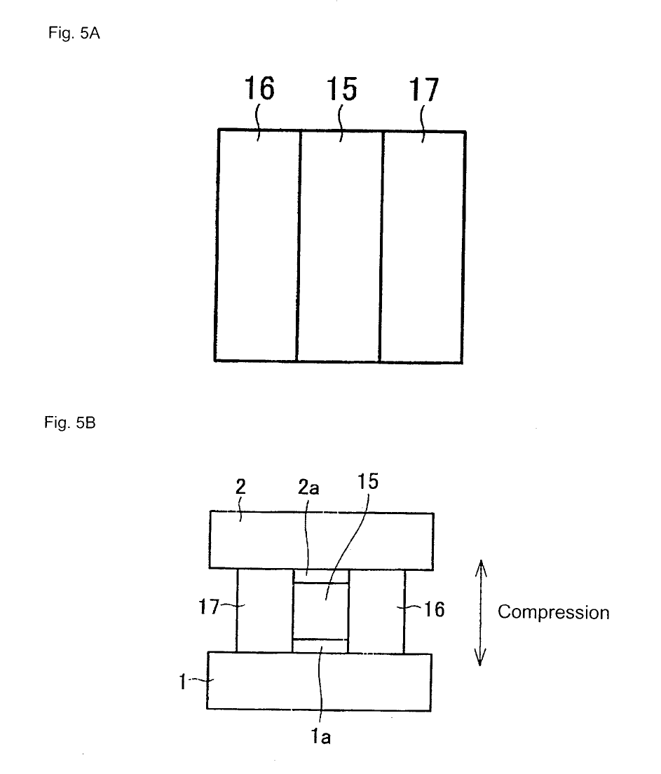

Hereinafter, with reference to FIG. 5, there will be described the connection between the radio device antenna 1 and the radio circuit board 2 through the elastomer connection portion 4. FIG. 5 are cross-sectional views illustrating the connection between the radio device antenna 1 and the radio circuit board 2 through the elastomer, wherein FIG. 5A illustrates a state before the pressing and FIG. 5B illustrates a state after the pressing.

As illustrated in FIG. 5A, the elastomer connection portion 14 is constituted by the elastic layers 16, 17 and the metal line layer 15 sandwiched therebetween. The elastic layers 16, 17 are made of an elastic resin. Although there is no particular limitation on the elastic resin, provided that it is a conventionally well known resin having elasticity, but it can be, for example, a natural rubber or a polymeric resin material.

Further, as illustrated in FIG. 5B, an electrical path 2a is provided on the radio circuit board 2 near the elastomer connection portion 14, while an antenna terminal la is provided in the feeding portion of the radio device antenna 1 near the elastomer connection portion 14. Further, in the elastomer connection portion 14, the antenna terminal la and the electrical path 2a are connected to each other through the metal line layer 15. Since the elastic layers 16, 17 are made of an elastic resin, the electrical path 2a and the antenna terminal la can be electrically connected to each other, by pressing the radio device antenna 1 and the radio circuit board 2 against each other.

By connecting the radio device antenna 1 and the radio circuit board 2 to each other through an elastomer, as described above, it is possible to simplify the processing for connection, in comparison with cases of connecting the radio device antenna 1 and the radio circuit board 2 to each other through soldering. Further, since the radio device antenna 1 and the radio circuit board 2 are electrically connected to each other at a state where the elastomer is compressed, it is possible to reduce the area of the radio device 13 which is occupied by the elastomer connection portion 14, thereby enabling further reduction of the size of the radio device. Further, although not illustrated in FIG. 4, the radio device 13 is provided with a fixation member for fixating the state where the elastomer connection portion 14 is compressed.

Further, the radio device antenna 1 usable in the radio device according to the present embodiment is not limited to a discone-shaped antenna, as described above. The radio device antenna can be, for example, a planer antenna. The aforementioned “planar antenna” means an antenna having a bar-shaped member placed within the same plane. The planar antenna according to the present invention includes patch antennas having various shapes, for example, antennas having rectangular cylindrical shapes and circular cylindrical shapes. By providing such a planar antenna in such a way that the predetermined bar member surrounds the radio circuit board 2, it is possible to utilize the area surrounded by the aforementioned bar-shaped member efficiently, thereby enabling realization of a radio device having a reduced size.

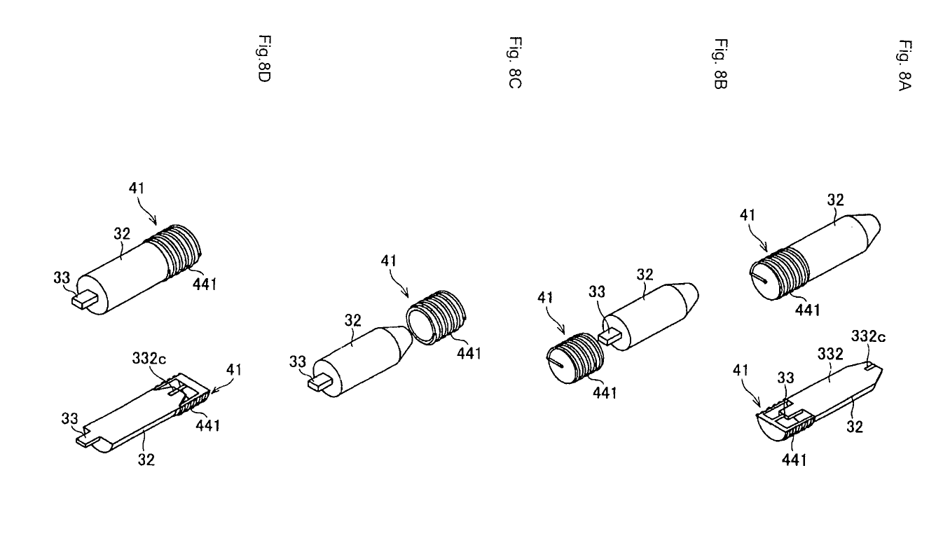

Further, the radio device antenna can be a helical antenna having a helical shape. The term “helical antenna” refers to an antenna having a helically wound electric wire, namely an electric wire wound in a coil shape. As such a helical antenna, there is, for example, a round-shaped helical antenna as illustrated in FIG. 8 which will be described later.

As illustrated in FIG. 8, the helical antenna is formed from a circular-cylindrical container and an electric wire wound around the outer wall thereof in a coil shape. Further, a radio circuit board 2 is placed within the area surrounded by the coil-shaped wound electric wire. Accordingly, it is possible to utilize the area of the helical antenna surrounded by the coil-shaped wound electrode efficiently, thereby realizing a radio device having a reduced size.

Further, in the radio device according to the present embodiment, the radio circuit board is placed in the area surrounded by a single electrode out of the two electrodes of the radio device antenna.

Accordingly, as the radio device antenna applicable to the present invention, any radio device antenna having an electrode capable of surrounding at least a portion of a radio circuit board can be applied to the radio device according to the present invention.

### Second Embodiment

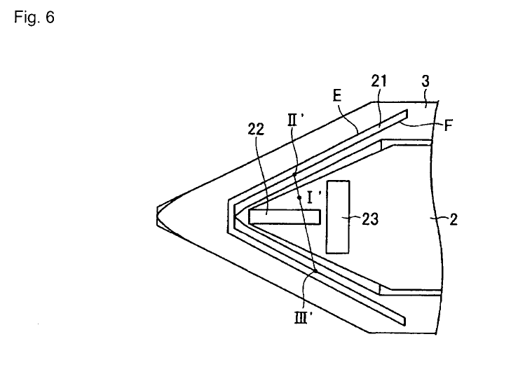

With reference to FIG. 6, there will be described a second embodiment of the present invention, in the following description. Further, other structures other than those which will be described in the present embodiment are the same as those of the aforementioned first embodiment. Further, for ease of description, components having the same functions as those of the components illustrated in the drawings of the aforementioned first embodiment are designated by the same reference characters, and description thereof will be omitted.

The radio device according to the aforementioned first embodiment is configured to include a connection means between the radio device antenna 1 and the radio circuit board 2. On the contrary, a radio device 20 according to the present embodiment has no connection means between a radio device antenna 21 and a radio circuit board 2 and includes a resonant antenna on the radio circuit board 2. Hereinafter, with reference to FIG. 6, there will be described the structure of the radio device 20 according to the present embodiment. FIG. 6 is a cross-sectional view illustrating the general structure of the radio device 20 according to the present embodiment.

As illustrated in FIG. 6, the radio device 20 includes the radio device antenna 21, the resonant antenna 22 and a high dielectric loss tangent layer 23.

The radio device antenna 21 has substantially a circular conical face having a planar face near its vertex and receives and transmits radio waves at a face E opposite from the radio circuit board 2. Further, the area surrounded by a face F of the radio device antenna 21 which is opposite from the transmission/reception face (the face E) thereof is a non-sensitive area. Further, the end portion of the radio circuit board 2 closer to the radio device antenna 21 is shaped in conformance to the shape of a case 3 which covers the face F of the radio device antenna 21. Further, in the radio device antenna 21, there is not provided a connection means between the radio device antenna and the radio circuit board 2, as in the radio device antenna 1 according to the aforementioned first embodiment. Namely, the radio device antenna 21 is a passive device.

Further, in the radio device 20, a straight line II′-I′ starting from a predetermined point I′ on the radio circuit board 2 and extending from the predetermined point I′ in the direction opposite from the direction from the predetermined point I′ to a predetermined point II′ on the radio device antenna 21 passes through a predetermined point III′ on the radio device antenna.

Namely, the radio circuit board 2 is provided such that an end portion thereof is placed in the area surrounded by the face F of the radio device antenna 21. Accordingly, the radio device 20 enables effectively utilizing the area surrounded by the face F of the radio device antenna 21, thereby realizing reduction of the size of the radio device.

Further, in the radio device 20, the resonant antenna 22 and the high dielectric loss tangent layer 23 are provided on the radio circuit board 2. The resonant antenna 22 includes a feeding portion and propagates radio waves to the radio device antenna through resonance. The radio waves radiated from the resonant antenna 22 are propagated to the radio device antenna 21 through resonance. Therefore, the radio device antenna 21 functions as an antenna, even at passive states.

By structuring the radio device 20 as described above, it is possible to eliminate the necessity of providing a connection portion for electrically connecting the radio device antenna 21 to the radio circuit board 2, thereby facilitating the fabrication of the radio device and enabling further reduction of the size of the radio device.

The high dielectric loss tangent layer 23 is provided at the side of the resonant antenna 22 closer to the radio circuit board 2. The high dielectric loss tangent layer 23 is made of a material having a higher dielectric loss tangent (tan δ), similarly to the high dielectric loss tangent layer 7 in the aforementioned first embodiment.

This can alleviate the influence of radio waves radiated from the resonant antenna 22 on the radio circuit board 2 or the influence of noises generated from the radio circuit board 2 on the resonant antenna 22.

Also, in cases where the radio device antenna is a helical antenna, such a high dielectric loss tangent layer provided between the helical antenna and the signal processing circuit can suppress the influence of noises generated from the signal processing circuit.

### Third Embodiment

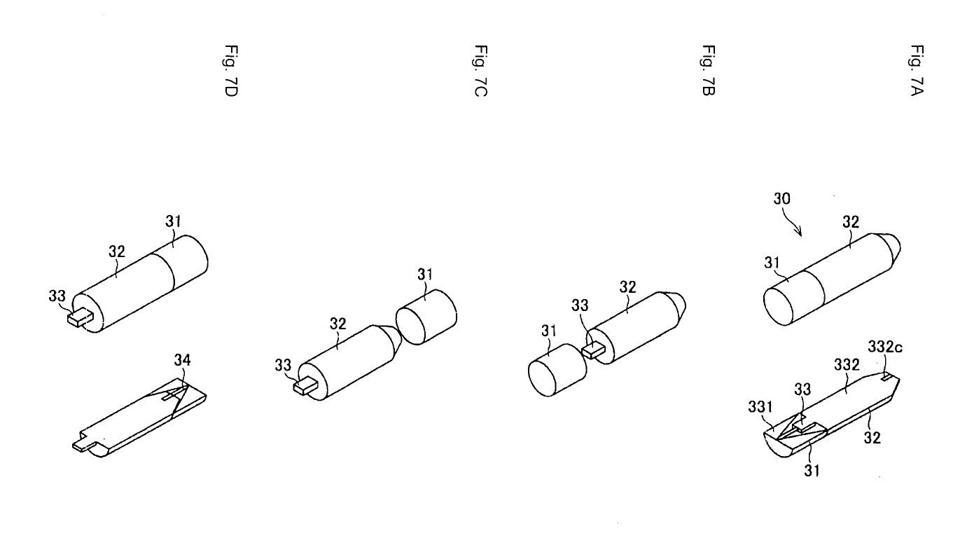

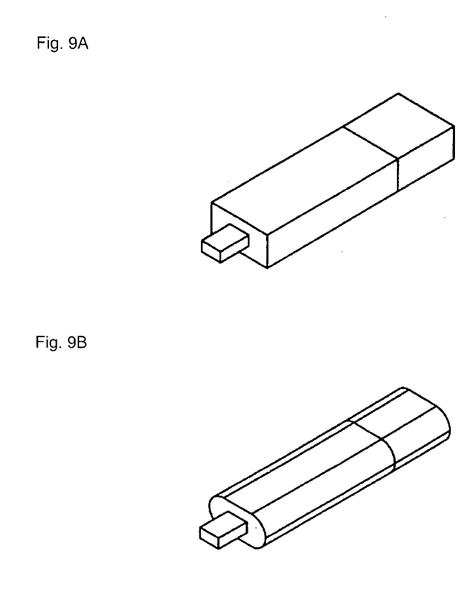

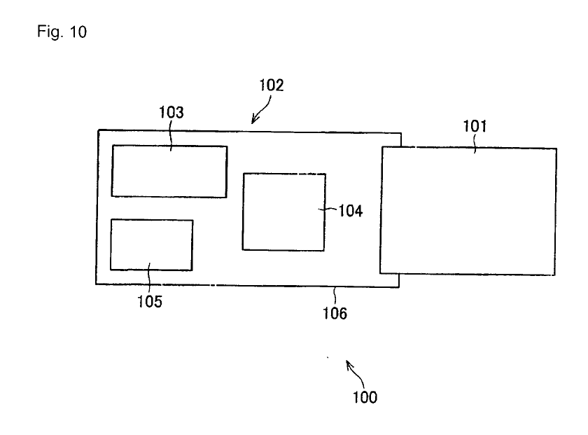

With reference to FIG. 7 and FIG. 9, there will be described a third embodiment of the present invention, in the following description. Further, other structures other than those which will be described in the present embodiment are the same as those of the aforementioned first and second embodiments. Further, for ease of description, components having the same functions as those of the components illustrated in the drawings of the aforementioned first and second embodiments are designated by the same reference characters, and description thereof will be omitted.

In the aforementioned first and second embodiments, the radio device antenna 1 and the radio circuit board 2 are configured such that they can not be disconnected from each other. On the contrary, a radio device according to the present embodiment is configured such that a radio device antenna 1 and a radio circuit board 2 can be disconnected from each other. Hereinafter, with reference to FIG. 7, there will be described the structure of the radio device 30 according to the present embodiment. FIG. 7 is an explanation view for describing the radio device according to the present embodiment, in a case where the radio device antenna has a discone shape. FIG. 7A illustrates the step of covering a plug with a cap antenna, FIG. 7B illustrates the step of removing the cap antenna from the plug, FIG. 7C illustrates the step of moving the cap antenna to a tip end of a radio circuit board case, and FIG. 7D is the step of mounting the cap antenna to the radio circuit board case.

As illustrated in FIG. 7, the radio device 30 is configured to include the cap antenna (cabinet) 31 for covering a radio device antenna 331, and the radio circuit board case 32 for covering a radio circuit board 332. Namely, the radio device 30 is configured to cover the radio device antenna 331 and the radio circuit board 332 with the separate cases and is configured to include the two cabinets which are the cap antenna 31 and the radio circuit board case 32.

The cap antenna 31 is provided with the discone-shaped radio device antenna 331. Further, the plug 33 is provided at one end of the radio circuit board case 32 in the longitudinal direction, and the plug 33 can be housed at a position corresponding to a non-sensitive area of the radio device antenna 331. Further, the other end portion of the radio circuit board case 32 in the longitudinal direction is shaped in conformance to the shape of the non-sensitive area of the radio device antenna 331. Further, at the tip end of the end portion of the radio circuit board case 32 opposite from the plug 33 in the longitudinal direction, there is provided a connector 332c to be electrically connected to the radio device antenna 331.

Further, there is no particular limitation on the plug 33 in the radio device 30, provided that it is a plug for connecting a conventionally known radio device to an electronic device such as a personal computer. For example, it is possible to employ a USB plug, an IEEE 1394 plug and the like.

Hereinafter, there will be described the mounting of the cap antenna 31 in the radio device 30 according to the present embodiment.

As illustrated in FIG. 7A, at first, the cap antenna 31 is mounted to the radio circuit board case 32 at its side provided with the plug 33. At this time, the plug 33 is placed at a position corresponding to the non-sensitive area of the radio device antenna 331.

Then, as illustrated in FIG. 7B, the cap antenna 31 is removed from the radio circuit board case 32 at its side provided with the plug 33. Then, as illustrated in FIG. 7C, the cap antenna 31 is moved to the end portion of the radio circuit board case 32 which is opposite from the plug 33. Then, as illustrated in FIG. 7D, the radio device antenna 331 is connected to the connector 332c. The end portion of the radio circuit board case 32 opposite from the plug 33 is shaped in conformance to the shape of the radio device antenna 331, which enables effective utilization of the non-sensitive area, thereby realizing reduction of the size of the radio device.

For connecting the radio device antenna 331 to the connector 332c, it is possible to utilize a conventionally known connection, provided that the connection allows disconnecting the radio device antenna. 331 and the connector 332c from each other. For example, for connecting the radio device antenna 331 to the connector 332c, it is possible to employ a connection through male-to-female connectors, for example.

As described above, the radio device 30 is configured to cover the radio device antenna 331 and the radio circuit board 332 with the separate cases. Further, the case which covers the radio device antenna 331 is caused to function as a protection means for protecting the plug 33. Accordingly, there is no need for providing additional protection means for protecting the plug 33 and the cap antenna 31 protects the plug 33, which can reduce the number of components, thereby further reducing the size of the radio device.

Further, as well as the structure which employs the discone-shaped radio device antenna 331 as the cap antenna 31, it is also possible to employ a helical-shaped helical antenna as a radio device antenna. Hereinafter, with reference to FIG. 8, there will be described a radio device 40 which employs a helical antenna having a helical shape as a radio device antenna. FIG. 8 is an explanation view for describing a radio device according to the present embodiment which employs a circular-shaped helical antenna as a radio device antenna. FIG. 8A illustrates the step of covering a plug with a cap antenna, FIG. 8B illustrates the step of removing the cap antenna from the plug, FIG. 8C illustrates the step of moving the cap antenna to a tip end of a radio circuit board case, and FIG. 8D illustrates the step of mounting the cap antenna to the radio circuit board case. Further, the radio circuit board case and the plug in the radio device 40 have the same structures as those of the radio circuit board case 32 and the plug 33 illustrated in FIG. 7, and description thereof is omitted herein. As illustrated in FIG. 8, the cap antenna 41 has a shape corresponding to that of a circular cylindrical container. The cap antenna 41 is provided with a radio device antenna 441. The radio device antenna 441 is formed from an electric wire wound around the outer wall of the circular cylindrical container in a coil shape, wherein the electric wire and the outer wall of the circular cylindrical container form transmission/reception faces. Further, the plug 33 is housed in the area surrounded by the radio device antenna 441.

Hereinafter, there will be described the mounting of the cap antenna 41 in the radio device 40 according to the present embodiment.

As illustrated in FIG. 8A, at first, the cap antenna 41 is mounted to the radio circuit board 32 at its side provided with the plug 33. At this time, the plug 33 is placed at a position corresponding to a non-sensitive area of the radio device antenna 441.

Then, as illustrated in FIG. 8B, the cap antenna 41 is removed from the radio circuit board case 32 at its side provided with the plug 33. Then, as illustrated in FIG. 8C, the cap antenna 41 is moved to the end portion of the radio circuit board case 32 opposite from the plug 33. Then, as illustrated in FIG. 8D, the radio device antenna 441 is connected to a connector 332c. At this time, the end portion of the radio circuit board case 32 opposite from the plug 33 is placed in the area surrounded by the radio device antenna 441, which enables effective utilization of the area surrounded by the radio device antenna 441, thereby realizing reduction of the size of the radio device.

Further, preferably, the cap antenna 31 which covers the radio device antenna 331 is made of a resin material. A resin material has plasticity and thus allows freely designing its shape through injection molding and the like. FIG. 9 illustrates examples of the shape of such a cap antenna 31. FIG. 9A illustrates a cap antenna 31 having a rectangular cylindrical shape, and FIG. 9B illustrates a cap antenna 31 having an elliptical cylindrical shape.

The cap antenna 31 can be shaped as illustrated in FIGS. 9A and 9B, which enables designing the shape of the cap antenna 31 properly depending on the size of the electronic device to be connected thereto, the installation space and the application thereof.

Further, the cases 3 for covering the radio device antennas 1 according to the first and second embodiments are preferably made of a resin material. This enables designing the shape of the radio device properly, depending on the size of the electronic device to be connected thereto, the installation space and the application thereof.

### Fourth Embodiment

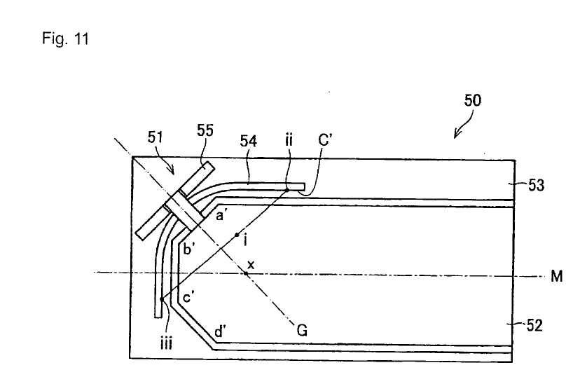

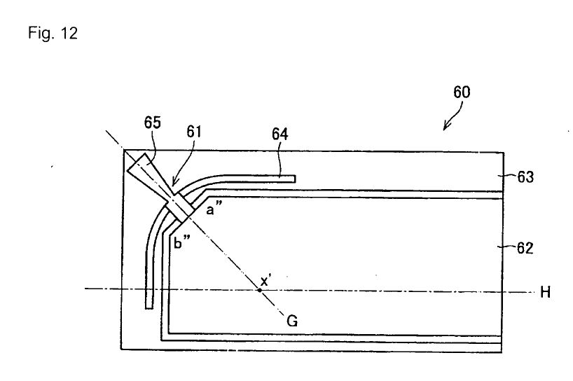

With reference to FIG. 11 and FIG. 12, there will be described a fourth embodiment of the present invention, in the following description. Further, other structures other than those which will be described in the present embodiment are the same as those of the aforementioned first embodiment. Further, for ease of description, components having the same functions as those of the components illustrated in the drawings of the aforementioned first embodiment are designated by the same reference characters, and description thereof will be omitted.

The radio device according to the first embodiment is configured such that the radio circuit board is connected to the radio device antenna symmetrically about the center line G. On the contrary, a radio device according to the present embodiment is configured such that the placement of a radio device antenna and a radio circuit board is not symmetrical about the center line G. Hereinafter, with reference to FIG. 11, there will be described the structure of the radio device according to the present embodiment. FIG. 11 is a cross-sectional view illustrating the general structure of the radio device according to the present embodiment.

As illustrated in FIG. 11, a radio device antenna 51 is a discone shaped antenna constituted by a feeding electrode 54 having a circular conical shape and an earth electrode (top electrode) 55 having a disk shape. The earth electrode 55 is provided near the vertex of the circular-conical-face shape of the feeding electrode 54. Further, the earth electrode 55 is concentrical and perpendicular to the center line G of the circular-conical-face shape of the feeding electrode 54. Further, similarly to in the aforementioned first embodiment, in the radio device antenna 51, the area surrounded by a face C of the feeding electrode 54 having points ii and iii thereon is a non-sensitive area.

Further, a radio circuit board 52 has edge portions having a trapezoidal shape connecting points a′, b′, c′ and d′ to one another. The trapezoidal shaped edge portions are constituted by an inclined edge portion a′b′ having the points a′ and b′, an edge portion b′c′ having the points b′ and c′, and an inclined edge portion c′d′ having the points c′ and d′. Further, the radio circuit board 52 is configured to be line-symmetrical about a symmetry axis M. Further, the term “inclined edge portions” means the edge portions inclined with respect to the symmetry axis or the longitudinal direction of the radio circuit board, out of the edge portions of the radio circuit board.

Further, the aforementioned inclined edge portion a′b′ and the aforementioned inclined edge portion c′d′ are formed at corners of the radio circuit board 52. Namely, the radio circuit board 52 has the inclined edge portion a′b′ and the inclined edge portion c′d′ at its corners.

In the radio device 50 according to the present embodiment, the radio device antenna 51 is connected at its feeding portion to the aforementioned inclined edge portion a′b′ of the radio device circuit 52. This can reduce the interval between the radio device antenna 51 and the radio circuit board 52, in comparison with cases of connecting the radio device antenna 51 to the radio circuit board 52 at an end portion thereof perpendicular to the symmetry axis M or the longitudinal direction (for example, the edge portion b′c′ illustrated in FIG. 11). This can reduce the size of a case 53 covering the feeding electrode 54, thereby reducing the area occupied by the case 53 in the entire radio device 50.

In other words, the radio device 50 is configured such that the radio device antenna 51 and the radio circuit board 52 are connected such that at least one of straight lines extending in the longitudinal direction of the radio circuit board 52 (for example, the symmetry axis M in FIG. 11) is intersected with the center line G of the circular conical shape of the feeding electrode 54 in the radio device antenna 51 and the intersection point X is positioned on the surface of the radio circuit board 52. Namely, it is configured such that the center line G is intersected with the symmetry axis M on the surface of the radio circuit board 52. On the contrary, the radio device according to the first embodiment is configured such that the radio device antenna and the radio circuit board are connected to each other, such that the center line of the circular-conical-face shape of the feeding electrode of the radio device antenna and the symmetry axis of the radio circuit board are substantially coincident with each other.

Further, similarly to the aforementioned embodiments, in the radio device 50, a straight line ii-i starting from a predetermined point i on the radio circuit board 52 and extending from the predetermined point i in the direction opposite from the direction from the predetermined point i to a predetermined point ii on the radio device antenna 51 passes through a predetermined point iii on the radio device antenna 51.

Namely, the radio device 50 is configured such that there is at least a single line passing through the radio circuit board 2 (for example, the straight line connecting the point ii and the point iii to each other, in FIG. 11), out of straight lines connecting predetermined two points on the radio device antenna 51.

In the radio device 50, the radio circuit board 52 is placed in the area surrounded by the face C′ of the feeding electrode 54 which is a non-sensitive area. This enables effectively utilizing the area surrounded by the face C′ of the feeding electrode 54, thereby realizing further reduction of the size of the radio device.

Further, while, in FIG. 11, there has been described a case where the radio device antenna 51 has a discone shape constituted by the feeding electrode 54 having a circular-conical face shape and the disk-shaped earth electrode 55, and the radio circuit board 52 is shaped to be line-symmetrical about the symmetry axis M, the shapes of the radio device antenna and the radio circuit board applicable to the radio device according to the present embodiment are not limited thereto. For example, the earth electrode (top electrode) can have a circular-conical-face shape (cone type), while the radio circuit board can be formed not to be line-symmetrical about the symmetry axis.

Hereinafter, with reference to FIG. 12, there will be described another structure of the radio device according to the present embodiment. FIG. 12 is a cross-sectional view illustrating another general structure of the radio device according to the present embodiment.

As illustrated in FIG. 12, a radio device antenna 61 is a biconical antenna constituted by a feeding electrode 64 having a circular-conical-face shape and an earth electrode (top electrode) 65 having a circular-conical-face shape. The feeding electrode 64 and the earth electrode 65 are placed plane-symmetrically such that the vertexes of these circular-cylindrical-face shapes are coincident with each other.

Further, the radio circuit board 62 has, at a corner portion thereof, an inclined edge portion a″b″ inclined with respect to the longitudinal direction thereof. The radio device antenna 61 is connected, at its feeding portion, to the aforementioned inclined edge portion a″b″ of the radio circuit board 62.

Namely, in the radio device 60, the radio device antenna 61 and the radio circuit board 62 are connected to each other, such that at least a single line H out of straight lines extending in the longitudinal direction of the radio circuit board 62 is intersected with the center line G of the circular conical shape of the feeding electrode 64 of the radio device antenna 61 and the intersection point X′ is positioned on the surface of the radio circuit board 62.

With the structure illustrated in FIG. 12, similarly, it is possible to reduce the size of the case 63 covering the feeding electrode 64, thereby reducing the area occupied by the case 63 in the entire radio device 60. As a result, it is possible to reduce the size of the entire radio device 60.

In the radio device according to the present invention, as described above, there is at least a single predetermined point as follows, on the aforementioned signal processing circuit. That is, a straight line starting from the predetermined point on the aforementioned signal processing circuit and extending from the predetermined point in the direction opposite from the direction from the predetermined point on the aforementioned signal processing circuit to a predetermined point on the aforementioned radio device antenna passes through the aforementioned radio device antenna. This enables effectively utilizing the area surrounded by a predetermined face of the radio device antenna or by a straight line thereon, thereby realizing further reduction of the size of the radio device. Further, even when the radio device antenna is such a large-sized antenna that occupies a larger part of the mounting area of the radio circuit board, it is possible to reduce the size of the device.

Further, illustrative embodiments or examples have been described in the section of Best Mode for Carrying Out the Invention merely for clarifying the technical content of the present invention, and the present invention is not intended to be narrowly interpreted restrictively to there illustrative examples. Embodiments provided by properly combining technical means disclosed in different embodiments without departing from the spirit of the present invention and the scope of the claims are also covered by the technical scope of the present invention.

### INDUSTRIAL APPLICABILITY

As described above, the radio device according to the present invention is configured to have the radio circuit board provided at a position corresponding to the non-sensitive area of the convex surface of the transmission/reception face of the radio device antenna. This can realize reduction of the size of the radio device. Therefore, as applications of the radio device according to the present invention, there can be exemplified PC-card type radio device, CF (compact flash (trade mark)) type radio device, SD-card type radio devices, IEEE 1394 type radio devices, or radio devices used in cabinets of hand-held devices such as cellular phones, PDAs and the like.

1. A radio device comprising a radio device antenna for transmitting and/or receiving signals, and a signal processing circuit for conducting predetermined processing on signals received at said radio device antenna and/or converting signals to be transmitted into signals adaptable to outputting from said radio device antenna,
wherein said radio device antenna comprises one or more electrodes, and
there is at least a single straight line passing through said signal processing circuit, out of straight lines connecting arbitrary two points on a single electrode out of said one or more electrodes.

2. The radio device according to claim 1, wherein said radio device antenna is a planar antenna.

3. The radio device according to claim 1, wherein
said radio device antenna is a discone-shaped antenna having a conical-face shaped surface and a planar surface, and
at least a portion of said signal processing circuit is placed in the area surrounded by said conical-face shaped surface.

4. The radio device according to claim 1, wherein
said radio device antenna is a helical antenna having a helical shape, and
at least a portion of said signal processing circuit is placed in the area surrounded by said helical shape.

5. The radio device according to claim 1, wherein
at least a portion of said signal processing circuit is shaped in conformance to the shape of said radio device antenna.

6. The radio device according to claim 1, comprising
a layer made of a high dielectric loss tangent material, between said radio device antenna and said signal processing circuit.

7. The radio device according to claim 1, further comprising connection means for connecting said radio device antenna and said signal processing circuit to each other,
wherein said connection means is provided between said radio device antenna and said signal processing circuit.

8. The radio device according to claim 7, wherein
said connection means includes a connecter at its side closer to said radio device antenna and includes an insertion electrode at its side closer to said signal processing circuit,
wherein said connecter and said insertion electrode are connected to each other in an insertion manner.

9. The radio device according to claim 7, wherein
said connection means connects said radio device antenna and said signal processing circuit to each other through a conductive elastic member,
wherein there is further provided securing means for securing said radio device antenna and said signal processing circuit.

10. The radio device according to claim 1, wherein
said radio device antenna is a passive device, and
said signal processing circuit is provided with a resonant antenna for propagating radio waves to said radio device antenna through resonance.

11. The radio device according to claim 2, wherein
at least a portion of said signal processing circuit is shaped in conformance to the shape of said radio device antenna.

12. The radio device according to claim 3, wherein
at least a portion of said signal processing circuit is shaped in conformance to the shape of said radio device antenna.

13. The radio device according to claim 4, wherein
at least a portion of said signal processing circuit is shaped in conformance to the shape of said radio device antenna.

14. The radio device according to claim 2, comprising
a layer made of a high dielectric loss tangent material, between said radio device antenna and said signal processing circuit.

15. The radio device according to claim 3, comprising
a layer made of a high dielectric loss tangent material, between said radio device antenna and said signal processing circuit.

16. The radio device according to claim 4, comprising
a layer made of a high dielectric loss tangent material, between said radio device antenna and said signal processing circuit.

17. The radio device according to claim 5, comprising
a layer made of a high dielectric loss tangent material, between said radio device antenna and said signal processing circuit.
